(19) United States
(12) Patent Application Publication
(10) Pub. No.: US 2013/0191784 A1
(43) Pub. Date: Jul. 25, 2013

(54) ELECTRONIC DEVICE, MENU DISPLAYING METHOD, CONTENT IMAGE DISPLAYING METHOD AND FUNCTION EXECUTION METHOD

(71) Applicant: SONY COMPUTER ENTERTAINMENT INC., Tokyo (JP)

(72) Inventor: Nobuharu Noto, Tokyo (JP)

(73) Assignee: SONY COMPUTER ENTERTAINMENT INC., Tokyo (JP)

(21) Appl. No.: 13/798,521

(22) Filed: Mar. 13, 2013

Related U.S. Application Data
(63) Continuation of application No. PCT/JP2010/006701, filed on Nov. 15, 2010.

(51) Int. Cl. G06F 3/0484

(52) U.S. Cl. CPC G06F 3/04842
USPC 715/834

(57) ABSTRACT

A content image displaying unit displays a content image on a display. A first acknowledgment unit acknowledges an instruction for selection of the displayed content image. A menu item displaying unit displays a plurality of menu items defined for the selected content image so as to surround the content image. A second acknowledgment unit acknowledges an instruction for selection of the displayed menu item. A function execution unit executes a function of the selected menu item. A menu item displaying unit situates a plurality of menu items along a single circle.

### BACKGROUND OF THE INVENTION

1. Field of the Invention

The present invention relates to an electronic device provided with a display and to the functions provided in the electronic device.

2. Description of the Related Art

Electronic devices such as mobile game devices and personal digital assistants (PDA) have been used widely. Recently, multifunctionnal electronic devices such as smartphones, in which functions of a cell phone and a PDA are integrated, have become popular. These electronic devices are provided with a large-capacity memory and a high-speed processor and allow users to enjoy a variety of applications by downloading content such as music, movies, and game software.

Electronic devices provided with a touch panel provide an excellent user interface that enables intuitive user operation. For example, user interfaces that allow selection of an icon by tapping a content image (icon) as displayed with a finger or user interfaces that allow the user to scroll a displayed image by sliding his or her finger over the panel surface have already been in practical use.

Further, physical computing engines (also referred to as physical engines) capable of controlling the movement or behavior of a three-dimensional (3D) virtual object are not only used in academic simulation but also installed in game devices. A physical computing engine is computer software for simulating mass, speed, friction, etc. and is primarily designed to run processes like collision determination between 3D virtual objects or dynamic simulation. The physical computing allows the movement or behavior of virtual objects to be represented in a virtual 3D space just as the movement or behavior of real objects in the real space.

Development of a touch panel based user interface should meet the challenges of improvement in operability and improvement in design. Preferably, the quality in both operability and design should be improved. Moreover, it is preferable that a touch panel based user interface be such that the movement or behavior of a virtual object represented on a display matches the movement or behavior of a real object in the real space. This will result in a user interface or an application that enables intuitive user operation.

### SUMMARY OF THE INVENTION

Accordingly, a purpose of the present invention is to provide a novel user interface and an application.

The electronic device according to at least one embodiment of the present invention is provided with a display and comprises: a first displaying unit configured to display a content image on the display; a first acknowledging unit configured to acknowledge an instruction for selection of a displayed content image; a second displaying unit configured to display a plurality of menu items defined for the selected content image so as to surround the content image; a second acknowledgment unit configured to acknowledge an instruction for selection of a displayed menu item; and an execution unit configured to execute a function of the selected menu item.

The electronic device according to another embodiment is provided with a display and comprises: a sensor configured to detect a movement of the electronic device; a storage configured to store a plurality of content images; a determination unit configured to determine whether the electronic device makes a predetermined movement by referring to a value detected by the sensor; an extraction unit configured to extract a plurality of content images from the storage when the electronic device makes the predetermined movement; and a display unit configured to display the plurality of extracted content images on a display.

The electronic device according to still another embodiment comprises: a touch panel including a display and a positional information output device configured to output positional information identifying a touched position on the display; a first display unit configured to display one or more content images on the display; an acknowledging unit configured to acknowledge the positional information output from the positional information output device; a definition unit configured to define an area as a selection area when the area is deemed as a closed or substantially closed area formed by the positional information acknowledged by the acknowledging unit successively over time; an identification unit configured to identify a content image included in the selection area; and an execution unit configured to execute a function defined for the identified content image.

Optional combinations of the aforementioned constituting elements, and implementations of the invention in the form of methods, apparatuses, systems, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the appearance of an electronic device according to an embodiment of the present invention;

FIG. 2 shows the overall configuration of functional blocks of the electronic device;

FIG. 3 shows functional blocks of the processing unit;

FIG. 4A shows a randomized arrangement of a plurality of content images on the display; and FIG. 4B shows a state in which the content image is moved rightward;

FIG. 5 shows menu items;

FIG. 6A shows menu items; and FIG. 6B shows that the menu items are rotated; and FIG. 6C shows that the finger is slid to the PLAY display area;

FIG. 7A shows an example where two menu items are displayed; FIG. 7B shows an example where four menu items are displayed; and FIG. 7C shows an example where six menu items are displayed;

FIG. 8A shows that a part of a display area does not fit within the display; and FIG. 8B shows display areas generated in the shape of an arc; and

FIG. 9A shows a plurality of content images; and FIG. 9B shows that a closed curve is drawn.

### DETAILED DESCRIPTION OF THE INVENTION

The invention will now be described by reference to the preferred embodiments. This does not intend to limit the scope of the present invention, but to exemplify the invention.

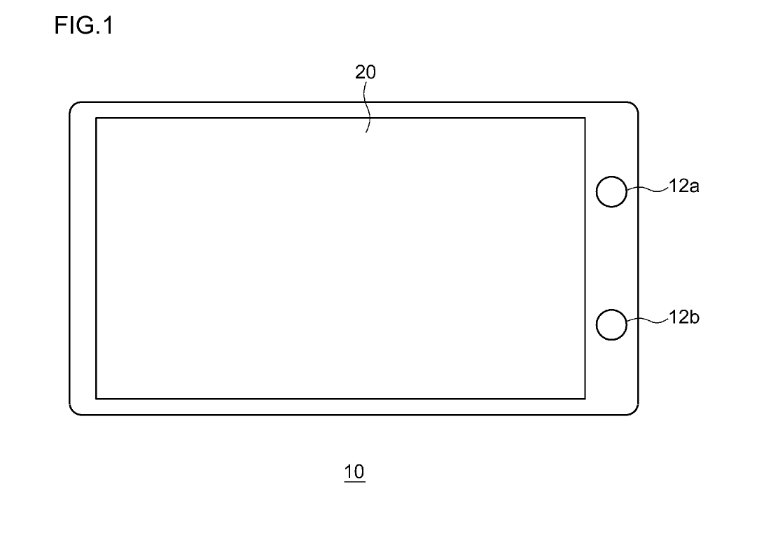

FIG. 1 shows the appearance of an electronic device according to an embodiment of the present invention. The electronic device 10 is capable of playing back music, movies, etc. or running game software by having associated application programs installed therein. Programs for implementing these functions may be preinstalled in the electronic device 10 for shipping. The electronic device 10 may be a cell phone provided with the function of a PDA or a mobile game device.

The electronic device 10 is provided with a touch panel 20 including a display and a touch sensor and is configured to detect the user's touch operation on the display. The electronic device 10 is further provided with buttons 12a and 12b and enables the user's button operation.

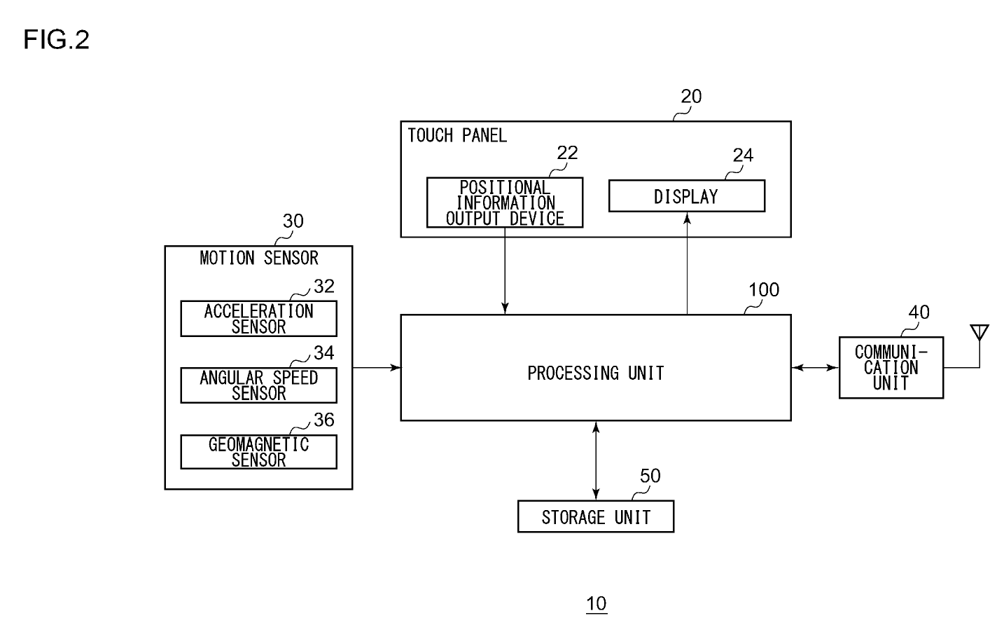

FIG. 2 shows the overall configuration of functional blocks of the electronic device 10. The electronic device 10 is provided with a touch panel 20, a motion sensor 30, a communication unit 40, a storage 50, and a processing unit 100. The communication unit 40 runs communication functions and downloads content data from an external content delivery server via a wireless network. If the content is music, the content data includes compressed audio data, a content image and content information associated with the music, etc. For example, the content image of the music includes an image of a jacket picture identifying the music, and the content information includes the name of the tune, playing time, composer, lyrics, etc. If the content is game software, the content data includes a program to run the game, a content image and content information associated with the game, etc. For example, the content image of the game includes a package image of the game title, and the content information of the game may include a brief description of the game story. The content data downloaded via the communication unit 40 is organized according to the type (category) of content and stored in the storage 50. The type of content depends on the application run. For example, the content is categorized into music, movies, games, etc. In the embodiment, the term “content” means a target of execution by an application. For example, the term encompasses content stored in an address book including photographic images and telephone numbers of other people. In this case, the application run is a phone call or a chat.

The storage 50 includes a hard disk drive (HDD), a random access memory (RAM), or the like. Data is written and/or read by the processing unit 100. Folders are created in the storage 50 for respective content types. For example, a music folder, a movie folder, and a game folder are created. The content data is stored in a folder determined by the content type.

The touch panel 20 is configured to include a positional information output device 22 and a display 24, which are connected to the processing unit 100. The display 24 is configured to display various information according to an image signal transmitted from the processing unit 100. In this embodiment, the display 24 displays a content icon (hereinafter, also referred to as “content image”), etc. The positional information output device 22 is provided with a touch sensor and is configured to detect a touch operation with a finger or a stylus pen and to output positional information identifying a touched position on the display 24 to the processing unit 100. The positional information output device 22 may be implemented by any of a variety of input detection means such as an electrical resistance film and a capacitive coupling assembly.

The motion sensor 30 is a detector for detecting the movement or orientation of the electronic device 10 and is provided with a three-axis acceleration sensor 32, a three-axis angular speed sensor 34, and a three-axis geomagnetic sensor 36. The motion sensor 30 periodically supplies detected values to the processing unit 100. The processing unit 100 identifies the movement or orientation of the electronic device 10 on a real-time basis from the detected values and causes the movement or orientation to be reflected in the execution of the application.

The processing unit 100 functions as a physical computing engine. For example, the processing unit 100 moves the content image displayed on the display 24. The processing unit 100 uses the detection value output from the motion sensor 30 and/or the positional information output from the positional information output device 22 to determine the direction of movement, the speed of movement, etc. of the content image. The processing unit 100 provides a user interface that enables intuitive user operation.

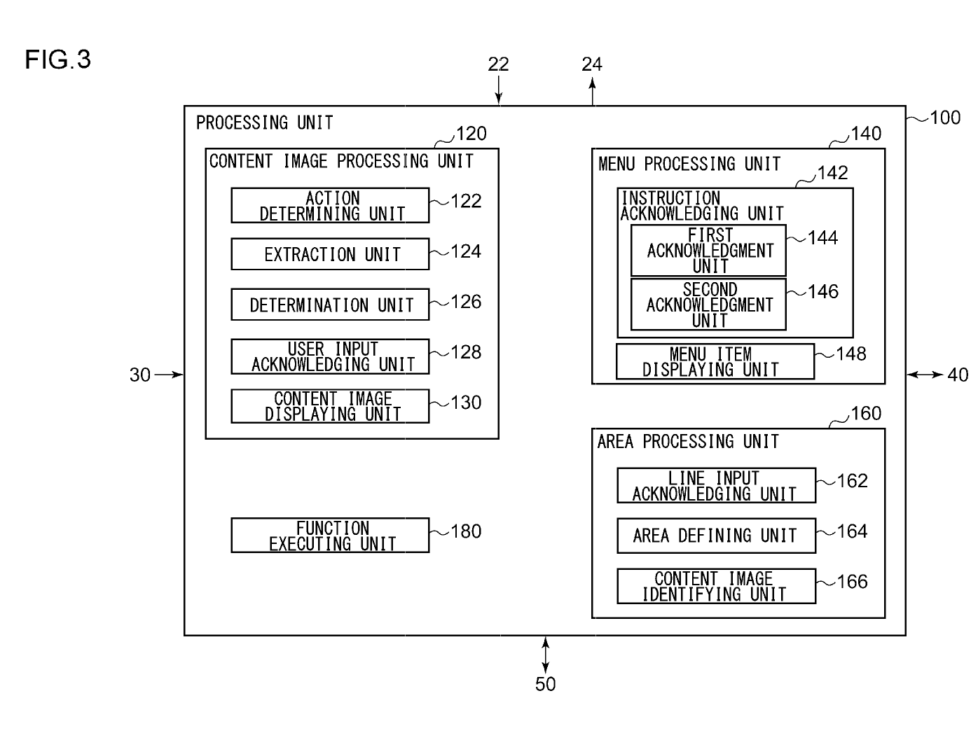

FIG. 3 shows functional blocks of the processing unit 100. The processing unit 100 is provided with a content image processing unit 120, a menu processing unit 140, an area processing unit 160, and a function executing unit 180. The content image processing unit 120 is provided with an action determining unit 122, an extraction unit 124, a determination unit 126, a user operation input acknowledging unit 128, and a content image displaying unit 130. The menu processing unit 140 includes an instruction acknowledging unit 142 and a menu item displaying unit 148. The instruction acknowledging unit 142 includes a first acknowledgment unit 144 and a second acknowledgment unit 146. The area processing unit 160 is provided with a line input acknowledging unit 162, an area defining unit 164, and a content image identifying unit 166.

The functions of the processing unit 100 are implemented by a CPU, a memory, a program loaded into a memory, etc. FIG. 3 depicts functional blocks implemented by the cooperation of these elements. Therefore, it will be obvious to those skilled in the art that the functional blocks may be implemented in a variety of manners by hardware only, software only, or a combination of thereof.

A summary will be given of the content displaying application and the user interface provided by the electronic device 10 according to the embodiment. The content displaying application activates content images on the display 24. In the initial state (at the start of the content displaying application), no content images are displayed on the display 24. When the user holds the electronic device 10 and swings it a predetermined number of times, a plurality of content images are read from the storage 50 and displayed on the display 24. Display of content images is controlled by a physical computing engine. When the electronic device 10 is moved after the content image is displayed on the display 24, the action of the content images, i.e. the direction and speed of movement, is determined in accordance with the value concurrently detected by the motion sensor 30 so that the content images are shown progressively dispersed on the display 24. This can be equated with a behavior of multiple cards spread on the table in the real space.

A virtual mass and a coefficient of friction with a virtual floor surface are defined for each content image moving on the display 24. The physical computing engine computes the speed of movement of each content image such that the speed is lowered progressively until the image comes to rest. When the user touches the content image that comes to rest with his or her finger, menu items are displayed around the content image. For example, in the case of music content, functions like PLAY, DELETE, INFO, etc. are defined as menu items. User selection of a displayed menu item initiates the execution of the function associated with the menu item.

The user can organize a plurality of content images into a group and can run a function commonly assigned to the group of content. As the user draws a line on the display 24 with his or her finger to surround content images desired to be grouped, the content images inside the line are grouped. Defining the area inside the line as a selection area, a new content image can be admitted to the group by placing the content image in the selection area. A content image already in the selection area can be removed from the group by placing the content image outside the selection area. A detailed description will be given of the content displaying application and the user interface of the electronic device 10 as described above.

<Content Displaying Application>

The content image processing unit 120 executes the content displaying application. The action determining unit 122 of the content image processing unit 120 functions as a physical computing engine and determines the action of the content image displayed on the display 24. More specifically, the action determining unit 122 defines a virtual mass and a coefficient of friction with a virtual floor surface for the content image displayed. As the user holds the electronic device 10 and moves the device, the action determining unit 122 determines the action of the content image. For example, when the electronic device 10 is moved leftward, the action determining unit 122 determines that a leftward force is applied to the content image in the virtual 3D space in which the content image is located and moves the content image leftward. The action determining unit 122 identifies status parameters such as the direction of movement, speed of movement, acceleration, etc. of the electronic device 10 by receiving a value detected by the motion sensor 30, and translates the status parameters into the action of the content image. If a plurality of content images are displayed on the display 24, the action determining unit 122 determines the action of each content image and moves the images on the display 24 accordingly.

The action determining unit 122 moves the content image in a space having a virtual floor surface that fits the rectangular display area of the display 24 and determines the action of the content image such that the content image takes a reflexive action as it hits the boundary of the virtual floor surface. The action determining unit 122 may use a known physical computing engine to control the action of the content images. The action determining unit 122 determines the action of the content images such that one of colliding content images is placed above the other instead of causing the colliding content images to be rejected by each other. For example, the content image with a greater moving speed may be controlled to be placed above the content image with a smaller moving speed. By lowering the moving speed in the event of collision, the behavior in the real space can be reproduced.

The action determining unit 122 may define the coefficient of friction for each content image. The action determining unit 122 may define the coefficient of friction in accordance with the type of content. For example, the action determining unit 122 may define the coefficient of friction of music content to be relatively small and define the coefficient of friction of game content to be relatively large. Further, the action determining unit 122 may define the coefficient of friction for a given type of content such that the coefficients differ depending on the content information. For example, a relatively small coefficient of friction may be defined for music content with a shorter playing time, and a relatively large coefficient of friction may be defined for music content with a longer playing time. In this case, the content image with a shorter playing time can move a longer distance on the display 24 than the content image with a longer playing time.

The determination unit 126 monitors the value detected by the motion sensor 30 and determines whether the electronic device 10 has moved in a predefined manner by referring to the detected value. In the embodiment, that the electronic device 10 is swung quickly a predetermined number of times (e.g. that the device 10 is swung three times over a predetermined period of time) is defined as a condition to display the content image on the display 24. Hereinafter, such a condition will be referred to as a “screen switching condition”. The screen switching condition is also used as a condition to switch content images after an image is displayed on the display 24. Therefore, when the image switching condition is met after the content displaying application is started, a predetermined number of content images will be displayed on the display 24. When the image switching condition is met subsequently, all or some of the content images displayed are replaced by new content images.

When the determination unit 126 determines that the electronic device 10 is swung three times over a predetermined period of time (e.g. one second) by referring to the value detected by the motion sensor 30, the unit 126 determines that the image switching condition is met and feeds an instruction to read content images to the extraction unit 124. The determination unit 126 defines a certain direction as a reference and determines that the image switching condition is met when the movement in the reference direction and the movement in the opposite direction are alternated three times. A known technology may be used for this determination. When the image switching condition is met, the extraction unit 124 extracts a plurality of content images from the storage 50. The user is expected to select the type of content extracted beforehand. The extraction unit 124 refers to the folder for the selected type and extracts a plurality of number of content images.

In this process, the extraction unit 124 may extract content images randomly. Alternatively, the extraction unit 124 may extract content images in accordance with a predetermined condition. The predetermined condition is defined in accordance with meta information of the content such as the number of times that the content is played back and the time and date of downloading. For example, in the case of music content, the extraction unit 124 may extract a predetermined number of content images in the descending order of the number of times that the music is played back in the past. Alternatively, the extraction unit 124 may extract content images in the reverse chronological order of time and date of downloading.

The content image displaying unit 130 displays a plurality of content images extracted by the extraction unit 124 at random positions on the display 24. As a result, the content images will look as scattered on a table. In other words, the content images will be displayed in a randomized arrangement.

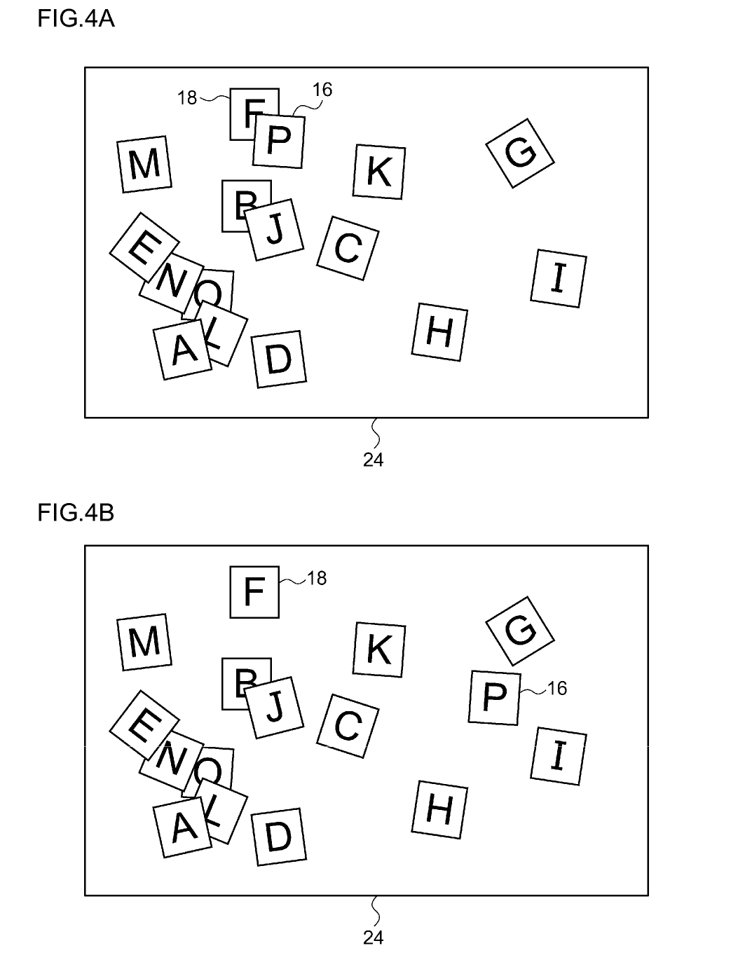

FIG. 4A shows a randomized arrangement of the plurality of extracted content images on the display 24. For identification, Roman characters are assigned to the content images. In the case of music content, the content images include jacket photos. An array of systematically arranged icons is generally seen in the related art. The electronic device 10 according to the embodiment is unique in that the content image displaying unit 130 does not arrange content images regularly but arranges the images scattered randomly, as shown in FIG. 4A.

By arranging content images randomly in the virtual 3D space, some content images will be occluded by other content images. This is because the electronic device 10 is designed to produce a realistic situation that would occur when a deck of cards are spread on a table in the real world. In a real-world situation like this, users will attempt to remove a card covering another card in order to see the card below. Similarly, the electronic device 10 according to the embodiment is designed such that the user can see the card below by removing the card on top. FIG. 4A shows that a content image 16 is located over a content image 18, hiding a part of the content image 18. The user can move the content image 16 by playing his or her finger on the content image 16 and moving the finger in a desired direction. The movement of the user's finger is detected and output by the positional information output device 22 as positional information. The action determining unit 122 determines the action of the content image 16 by referring to the output positional information.

FIG. 4B shows a state in which the content image 16 is moved rightward. When the user places his or her finger on the content image 16 in the state shown in FIG. 4A and slides the finger rightward, the action determining unit 122 detects that a rightward force is exerted on the content image 16 and determines the speed of rightward movement of the content image 16 by referring to the sliding speed of the finger. More specifically, as the user operation input acknowledging unit 128 receives positional information from the positional information output device 22 and delivers the information to the action determining unit 122, the action determining unit 122 determines the action of the content image by referring to the time-varying positional information.

For example, the action determining unit 122 may determine the number of content images that should be moved by referring to the finger pressure on the content image 16. For example, if the value of the pressure is smaller than a predetermined threshold value P1, the action determining unit 122 may move only the topmost content image 16. If the pressure is between P1 and P2, both inclusive (P2>P1), the unit 122 may also move the content image 18 immediately beneath. By using the physical computing engine, the content image processing unit 120 can give the user with simulated experience of user operation in the real space.

The content image displaying unit 130 displays the content image on the display 24 in accordance with the action determined by the action determining unit 122. The content image may be rotated as it is moved. If the content image is upside down when it comes to rest, it is uncomfortable for the user to see. For this reason, the content image displaying unit 130 adjusts the orientation of the content image when bringing the content image to rest.

The content image displaying unit 130 keeps track of the vertical orientation of each content image. The content image displaying unit 130 monitors the vertical (from top to bottom, i.e. downward) vector of the content image. If the angle of the vertical vector of the content image at rest as determined by the action determining unit 122 is below the horizontal direction of virtual floor surface, there is no need for adjustment. Meanwhile, if the angle of the vertical vector of the content image at rest is above the horizontal direction of the virtual floor surface, the content image is further rotated so that the angle is below the horizontal direction. This brings all content images at rest to be in an orientation easy for the user to view and allows the user to see the content images comfortably.

According to the content displaying application of the embodiment, as the user moves the electronic device 10 slightly, the plurality of content images displayed on the display 24 can be moved in association with the movement. Therefore, if the user wishes to change the display status of a plurality of randomly arranged content images, the user may move the electronic device 10 slightly to change the display status to show the plurality of content images further scattered.

The user may use the electronic device 10 while walking so that the electronic device 10 is not actually completely at rest. Therefore, the action determining unit 122 monitors the acceleration component of the electronic device 10 by referring to the value detected by the motion sensor 30. If the acceleration component exceeds the predetermined value A1, the action determining unit 122 determines the action of the content image, using the physical computing engine. This can avoid a situation in which the display status is changed as a result of slight movement by hand as the user attempts to select a content image. Therefore, user friendliness is improved.

As mentioned above, when the determination unit 126 determines that the image switching condition is met, the extraction unit 124 reads a new content image from the storage 50 and the content image displaying unit 130 switches content images. For example, given that the image switching condition requires that the user swing the electronic device 10 three times over a predetermined period of time, it is difficult for the user to see the display 24 while swinging the electronic device 10. Therefore, supposing that the user swings the device six times, the user cannot see the content image displayed to replace the previous image when the device is swung three times. Instead, the user will see the image displayed to replace the previous image when the device is swung six times. Therefore, the first switching will be useless. It is therefore preferable that the content image displaying unit 130 switches content images when the image switching condition is met and the swinging action by the user is subsequently completed. It is also preferable that the determination unit 126 monitors the swinging action by the user when the switching of content images is completed. This ensures that content images are switched only while they can be viewed by the user. For example, if the display 24 can display 20 content images and the user would like to display content images in the descending order of the number of times of playback, content images can be presented to the user in the descending order of the number of times of playback by controlling the process of switching as described above.

When the image switching condition is met while content images are being displayed on the display 24, the extraction unit 124 extracts from the storage 50 as many content images as the number of content images currently displayed. The content image displaying unit 130 displays the plurality of content images extracted in place of all content images currently displayed. By replacing the content images entirely, a whole new set of content images can be presented to the user.

When the image switching condition is met while content images are being displayed on the display 24, the extraction unit 124 may extract from the storage 50 fewer content images than the content images currently displayed, and the content image displaying unit 130 may display the extracted content images to replace some of the content images currently displayed. It is preferable to maintain the number of content images as a whole unchanged before and after the switching. Therefore, the content image displaying unit 130 prevents as many currently displayed content images as the number of extracted content images from being displayed any longer. As compared with the case where the content images are replaced entirely, displayed images will be updated progressively so that user can easily recognize the connection to the display before the switching.

<User Interface for Presenting a Menu>

A plurality of menu items are defined for a content image displayed by the content displaying application. For example, in the case of music content, functions like PLAY, DELETE, INFO, etc. are defined as menu items. When the user selects a content image displayed on the display 24 of the electronic device 10 according to the embodiment, a plurality of menu items are displayed. By selecting one of the menu items, the function mapped to the selected menu item is executed. The menu processing unit 140 in the electronic device 10 provides a user interface for presenting a menu.

When the user touches a content image displayed on the display 24, the first acknowledgment unit 144 in the instruction acknowledging unit 142 receives positional information from the positional information output device 22. By determining that the positional information matches the display position of the content image, the first acknowledgment unit 144 acknowledges an instruction for selection of the displayed content image. When the first acknowledgment unit 144 acknowledges the instruction for selection, the menu item displaying unit 148 displays a plurality of menu items defined for the selected content image such that the menu items surround the content image. The menu displayed when the content image 16 of music content shown in FIG. 4B is selected will be discussed below. A similar discussion applies to when other content images are selected.

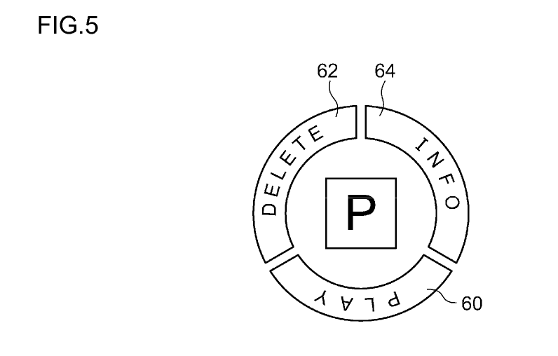

FIG. 5 shows a plurality of menu items displayed to surround the selected content image. As shown in the figure, a PLAY display area 60, a DELETE display area, and an INFO display area 64 are displayed as menu items around the content image. The content image displaying unit 130 displays as a background of the menu items a blurred version of the image as shown in FIG. 4A or 4B previously displayed.

When the use selects any one of the menu items by his or her finger, the second acknowledgment unit 146 receives positional information from the positional information output device 22. By determining that the positional information matches the display position of the menu item, the second acknowledgment unit 146 acknowledges an instruction for selection of the displayed menu item. For example, when the user touches the PLAY display area 60, the second acknowledgment unit 146 recognizes that the PLAY function for the music content is selected and forwards the instruction for selection to the function executing unit 180. The function executing unit 180 executes the function mapped to the selected menu item with the result that the music content is played back. When the DELETE display area 62 is selected, the function executing unit 180 deletes the music content from the storage 50. When the INFO display area 64 is selected, the function executing unit 180 displays the content information.

In the user interface shown in FIG. 5, a plurality of menu items are displayed on a circle having a certain width around the content image. The menu items are displayed in arc-like areas having the same angular range around the content image. For example, if it is desired that three menu items be displayed, the display area of each menu item is defined to be an angular range of about 120° (=360°/3). If it is desired that four menu items be displayed, the display area is defined to be an angular range of about 90° (360°/4). The display areas are defined to be of the same shape. By displaying a plurality of menu items concentrically, the distance between the content image and the menu item is ensured to be uniform.

In the related art, a pull-down menu is commonly used as a method of presenting menu items. A pull-down menu contains a list of menu items in a single window and so is excellent in terms of viewability. It has a drawback, however, in that the user could easily make an error in a user operation in, for example, a mobile terminal device with a small display 24. In particular, an error is more likely to occur in finger movements on a small-screen touch panel because the menu items are close to each other.

Meanwhile, according to the user interface shown in FIG. 5, a plurality of menu items are displayed to surround a content image. The user only has to initially place his or her finger on the content image and move the finger in the direction of the menu item desired to be selected. Accordingly, an error is less likely to occur. The same is true of a stylus pen operation. The embodiment provides a user interface superior to pull-down menu operation in terms of operability and design.

Sub-menu items may be defined for a menu item. In this case, when the user selects a menu item, a plurality of sub-menu items will be displayed around the menu item. Where there are a large number of functions defined for a content image, the menu item displaying unit 148 may not display all menu items at once. For example, by defining sub-menu items and hierarchically displaying the menus in several successive steps, the amount of information presented until a desired function is executed can be reduced.

The menu processing unit 140 according to the embodiment provides the user with two methods of selecting a menu item. In the first method of selection, when the user touches a content image, the first acknowledgment unit 144 acknowledges an operation of touching the content image as an instruction for selection. The menu item displaying unit 148 displays a plurality of menu items concentrically around the content image. The user slides his or her finger, continuing to touch the touch panel 20 with the finger. When the user releases the finger, the second acknowledgment unit 146 acknowledges the releasing action as an instruction for selection of a menu item. In other words, the user operation of touching a content image is used as an instruction for selection of the content image. The user operation of continuing to touch the touch panel 20 and then releasing the display area of the menu item (the action of canceling the touched state) is used as an instruction for selection of a menu item. Described above is the first method of selecting a menu item.

In the second method of selection, when the user taps a content image, the first acknowledgment unit 144 acknowledges an operation of tapping the content image as an instruction for selection. The menu item displaying unit 148 displays a plurality of menu items concentrically around the content image. When the user taps a displayed menu item, the second acknowledgment unit 146 acknowledges the tapping operation as an instruction for selection of a menu item. In other words, the user operation of tapping a content image is used as an instruction for selection of the content image, and the user operation of tapping the display area of a menu item is used as an instruction for selection of the menu item. Described above is the second method of selecting a menu item.

The user operation of tapping a content image in the second method of selection is an operation of lightly hitting the content image displayed on the touch panel 20 and so is a kind of touch operation. The user operation of tapping a content image in the first selection method differs in that the touched state is maintained after the content image is touched. The instruction acknowledging unit 142 can duly acknowledge an instruction according to each of these method of selection so as to allow the menu item displaying unit 148 to display menu items.

When the first acknowledgment unit 144 acknowledges a touch operation on a content image, the unit 144 determines whether the duration of touch is shorter than a predetermined period of time T1. For example, the predetermined period of time T1 is about 0.3 seconds. If the duration of touch is shorter than the time T1, the first acknowledgment unit 144 identifies the touch operation as a tap operation and as an instruction for selection according to the second method of selection. The first acknowledgment unit 144 informs the menu item displaying unit 148 that a content image is selected and communicates to the second acknowledgment unit 146 that an instruction for selection according to the second method of selection should be monitored. This allows the second acknowledgment unit 146 to acknowledge a tap operation in the display area of a menu item as an instruction for selection of the menu item.

Meanwhile, if the duration of touch is longer than the time T1, the first acknowledgment unit 144 identifies an instruction for selection according to the first method of selection. The first acknowledgment unit 144 informs the menu item displaying unit 148 that a content image is selected and communicates to the second acknowledgment unit 146 that an instruction for selection according to the first method of selection should be monitored. This allows the second acknowledgment unit 146 to acknowledge the continuation of the touched state, movement of the finger to the display area of a menu item, and release of the finger at the display area as an instruction for selection of menu item.

By providing two types of method of selecting a menu item to the user, the menu processing unit 140 allows the user to select a menu item with an operation preferred by the user. Since the first acknowledgment unit 144 is configured to identify which of the methods of selection is used to provide an instruction for selection by referring to the duration of touch, the user can select a menu item without minding the process in the electronic device 10.

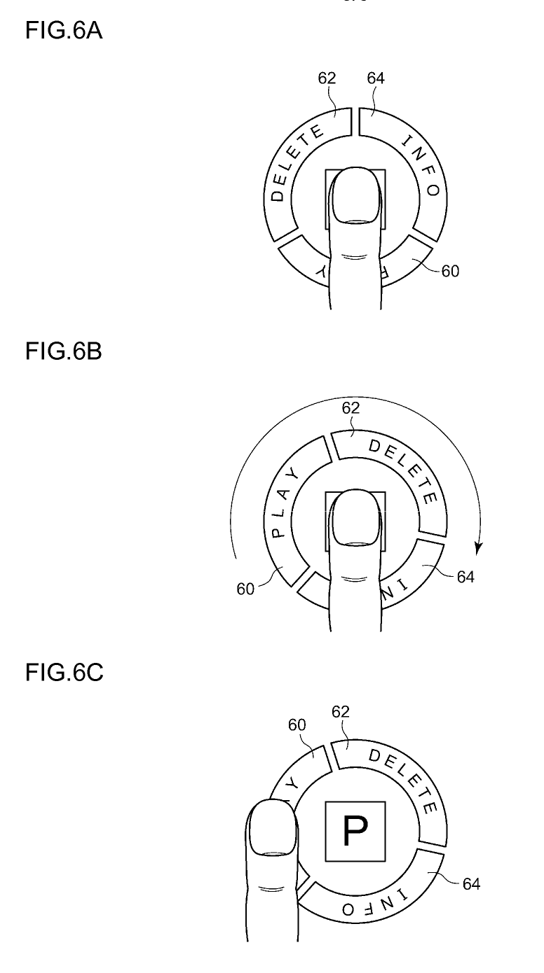

FIG. 6A shows menu items displayed when the finger touches a content image. If a menu item is selected according to the first method of selection, the finger touching the content image will hide a part of a menu item as a plurality of menu items are displayed. FIG. 6A shows that the DELETE display area 62 and the INFO display area 64 are displayed but a part of the PLAY display area 60 is hidden. Each display area is marked with characters representing the assigned function. For the PLAY display area 60, the characters cannot be read. To address this, the menu item displaying unit 148 rotates the menu items around the content image when a plurality of menu items are displayed.

FIG. 6B shows that the menu items are rotated. The menu item displaying unit 148 rotates the plurality of menu items so that a rotation is completed once in 5-10 seconds. In the illustrated example, the menu items are rotated clockwise, but they can be rotated counterclockwise. The PLAY display area 60 hidden by the finger in FIG. 6A will be visible as a result of the rotation. This allows the user to see the character (PLAY) drawn in the PLAY display area 60 and slide the finger to the PLAY display area 60, maintaining contact of the finger with the touch panel 20. FIG. 6C shows that the finger is slid to the PLAY display area 60. When the user detaches the finger from the touch panel 20 in the state shown in FIG. 6C, the second acknowledgment unit 146 acknowledges an instruction for selection of the menu item.

When the finger begins to be moved (slid) away from the content image, the menu item displaying unit 148 may suspend the rotation of the menu items. The menu item displaying unit 148 detects that the finger is removed from the content image by referring to the positional information output from the positional information output device 22 and suspends the rotation accordingly. This defines the destination of the finger so that the user can easily slide the finger to the display area. The menu item displaying unit 148 may suspend the rotation when the finger moves to the display area. This can prevent the display area beneath the finger from being changed to a different display area before the user releases the finger.

The menu item displaying unit 148 may rotate the menu items in the case of the second method of selection as well as in the case of the first method of selection. By rotating the menu items, it is expected that the user's attention is drawn more closely to the menu, facilitating the user operation for selection.

Described above is an example in which the menu item displaying unit 148 displays three menu items. Examples will be shown below in which other numbers of menu items are displayed. Upon being notified by the first acknowledgment unit 144 of the selected content image, the menu item displaying unit 148 dynamically creates a user interface for selection of a menu item in accordance with the number of menu items defined for the selected content image. More specifically, the menu item displaying unit 148 defines the size of the display area for the menu items in accordance with the number of menu items defined for the selected content image.

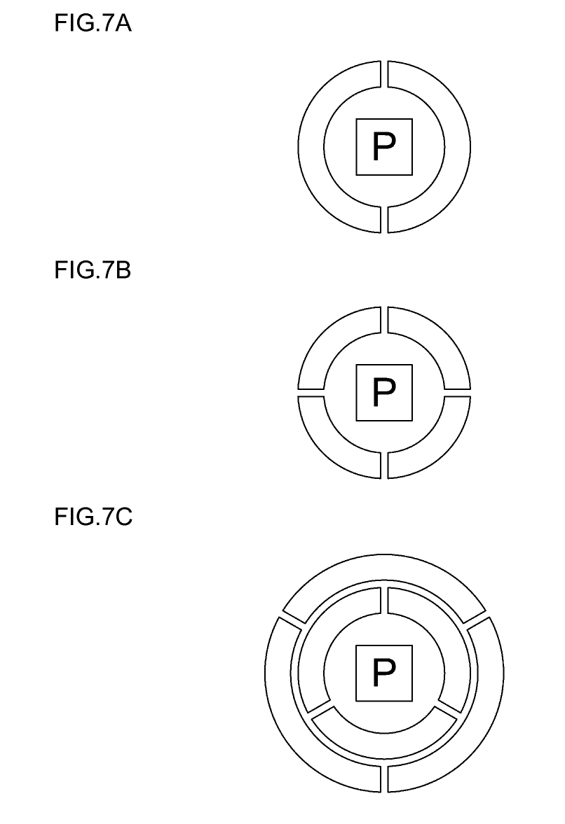

FIG. 7A shows an example where two menu items are displayed; and FIG. 7B shows an example where four menu items are displayed. To display two menu items, a circle having a certain width is split into two so as to create display areas. To display four menu items, a circle having a certain width is split into four so as to create display areas.

FIG. 7C shows an example where six menu items are displayed. As shown in the figure, each of the two circles (i.e. small and large circles) is split into three around the content image so as to create display areas. When the number of menu items is increased to a certain number (e.g. six) or larger, the menu item displaying unit 148 increases the number of circles so as to form display areas in two arrays. If 15 display areas are formed on a single circle to display 15 menu items, an error in user operation would be likely to occur. It is therefore favorable to maintain high operability by providing an upper limit to the number of display areas that can be formed per a single circle. The plurality of display areas will be formed concentrically. It is preferable that the upper limit to the number of display areas that can be formed be larger for the outer circle than for the inner circle. In situating a plurality of display areas on two or more circles, it is ensured that the number of display areas located on the inner circle is equal to or fewer than the number of displayed areas located in the outer circle.

The menu item displaying unit 148 may count the number of times that each menu item is selected and retain the count. The menu item displaying unit 148 situates menu items with a relatively larger count (i.e. menu items selected relatively more frequently) on the inner circle. By locating frequently selected menu items on the inner circle, which is easily reached by a user operation, the likelihood of error in a user operation is reduced.

The menu items on the first (inner) circle may be rotated in a direction opposite to the direction in which the menu items on the second (outer) circle are rotated. In this way, a user interface with excellent design can be built.

Referring back to FIG. 6C, the menu item displaying unit 148 may retain the display state occurring when an instruction for selection of a menu item mapped to the content image 16 is given so that the menu may be displayed in the same status next time. For example, if the PLAY display area 60 is selected and the playback function is executed accordingly, the likelihood that the playback function will be executed for the content at the next opportunity would be high. It is therefore preferable in this case that the PLAY display area 60 be located at a position in which it can easily be selected, when the menu items are displayed. For example, it is not preferable that the area is displayed at a position hidden by the finger as shown in FIG. 6A.

It is therefore preferable that the menu item displaying unit 148 stores the arrangement of menu items occurring when a function mapped to a content image is selected and present the stored arrangement to the user when the content image is selected next time. This allows the user to select a desired menu item immediately without waiting while the menu items are being rotated.

The menu item displaying unit 148 may store the arrangement of menu items for each type of content image instead of for each content image. For example, the arrangement of menu items occurring when a function mapped to a content image for music content is selected may be stored so that, when a different content image of the same type (music content) is selected, the menu items may be presented in the same arrangement which has been stored.

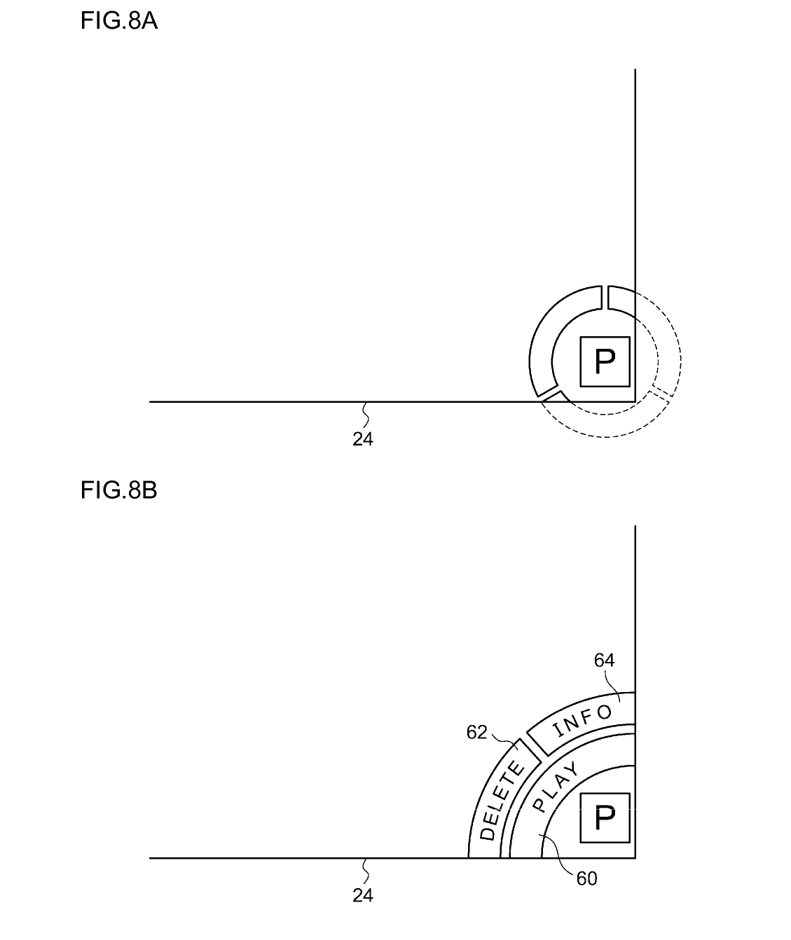

The user interface for presenting a menu according to the embodiment displays menu items to surround a selected content image. For this reason, the circle forming a display area may not fit within the display 24, depending on the position of the content image. FIG. 8A shows that a part of the display area does not fit within the display 24. The part that does not fit is indicated by dotted lines.

When the first acknowledgment unit 144 acknowledges an instruction for selection of a content image, the menu item displaying unit 148 determines whether the display area of a menu item that should be displayed fits within the display 24. First, the menu item displaying unit 148 refers to the number of menu items defined for the content image and identifies the outer perimeter of the display area of the menu item. More specifically, the menu item displaying unit 148 identifies the radius from the center of the content image by determining the required number of circles by referring to the number of menu items. The menu item displaying unit 148 determines whether all of the display areas of the menu items can be displayed on the display 24 by referring to the coordinates of the center of the content image and the radius of the outer perimeter. If the menu item displaying unit 148 determines that all of the display areas can be displayed on the display 24, the menu item displaying unit 148 displays the menu items as shown in FIGS. 5 and 7.

Meanwhile, if the menu item displaying unit 148 determines that a part of a display area cannot be displayed on the display 24, the menu item displaying unit 148 generates a display area by drawing an arc. FIG. 8B shows display areas generated in the shape of an arc. The minimum area is predefined for a display area in order to maintain high operability. Preferably, the menu item displaying unit 148 has a knowledge of the minimum display area, and determine the number of arcs and define display areas such that each display area is equal to or larger than the minimum area. It is preferable that the most frequently selected menu item be located on the arc closest to the content image, i.e. the innermost arc.

If the positional information output device 22 is designed to detect an input according to the capacitive coupling method, capacitive coupling occurs merely by bringing the finger close to the touch panel 20. In the above described embodiment, the first acknowledgment unit 144 acknowledges an instruction for selection of a content image by detecting a touch operation. Alternatively, the first acknowledgment unit 144 may acknowledge an instruction for selection by detecting a change in electrostatic capacitance occurring when the finger is brought close to the touch panel 20.

<User Interface for Grouping>

Described above is an example where a function defined for a single content image is executed. In the case of music, there will be a need to play back a plurality of pieces of music at once, for example. To address this requirement, the area processing unit 160 of the electronic device 10 according to the embodiment provides a user interface capable of grouping content easily.

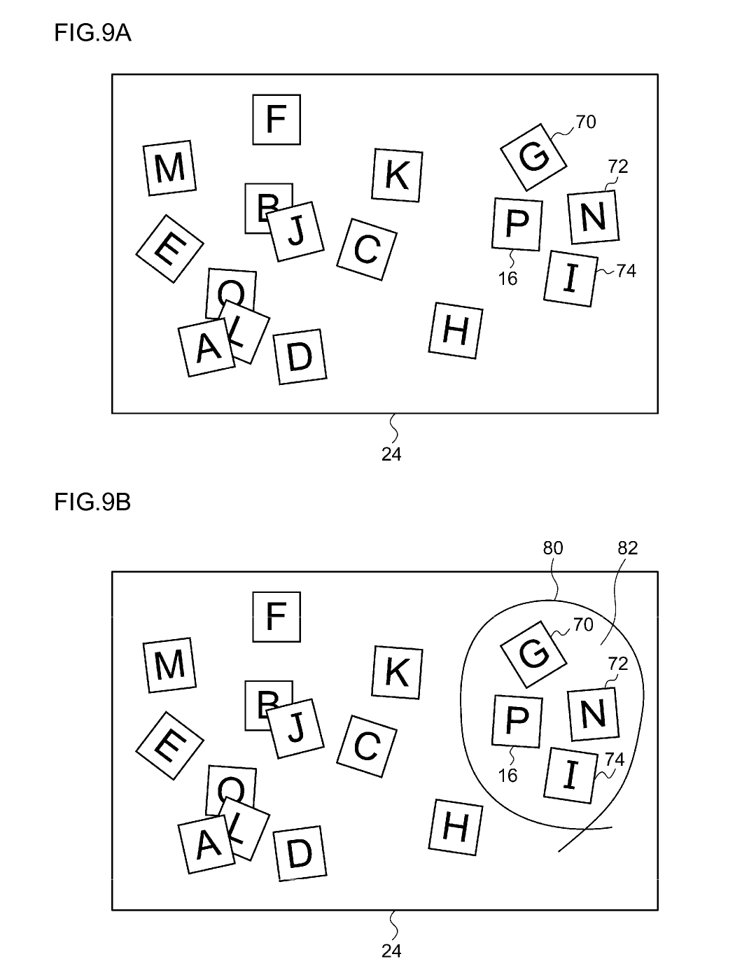

FIG. 9A shows a plurality of content images located on the display 24. The user brings a plurality of content images 16, 70, 72, and 74 desired to be grouped in the right of the screen. In this state, the user slides his or her finger on the touch panel 20 so as to encircle the plurality of content images 16, 70, 72, and 74. The line input acknowledging unit 162 acknowledges positional information output from the positional information output device 22.

The line input acknowledging unit 162 acknowledges positional information successively over time and displays a predetermined color at a position defined by the acknowledged positional information (i.e. the position over which the finger is slid). This displays a continuous free-form curve of a predetermined color on the display 24. When the area defining unit 164 determines that a closed area or a substantially closed area is formed by referring to the positional information acknowledged successively over time by the line input acknowledging unit 162, the unit 164 defines the area as a selection area.

FIG. 9B shows that a closed curve 80 is drawn. The area defining unit 164 determines whether the drawn curve is a closed curve 80 by referring to the positional information acknowledged successively over time. Whether the curve is a closed curve is determined by whether the head of a curve intersects a curve already drawn. Even if the head does not intersect the curve already drawn, the area defining unit 164 determines that the area is substantially closed if the head is at close proximity to the curve already drawn. The content image identifying unit 166 identifies the content images 16, 70, 72, and 74 included in the selection area and groups the images. Common function is executed against the grouped content images. In the case of music content, the grouped content is used as a play list and played back sequentially by the function executing unit 180.

In a sense, a selection area 82 bounded by the closed curve 80 is dealt with as one item of content. In other words, when the user touches the selection area 82, the menu processing unit 140 displays menu items. When the user selects a menu item, the function executing unit 180 executes a function defined commonly for the grouped content images. The content image identifying unit 166 may not group the content images on the condition that the entirety of a content image is located within the selection area 82. The content image identifying unit 166 may include the content image in a group so long as a part of the content image (e.g. half of the content image or more) is located within the selection area 82.

Once the area defining unit 164 defines the selection area 82, the selection area 82 is used as an area for grouping until the definition is cleared. In other words, when the user moves a new content image so as to include it in the selection area 82, the content image is added to the group. When a content image already included in the selection area 82 is removed outside the selection area 82, the content image is excluded from the group. Thus, by using the intuitive operability of the touch panel 20 and using the closed curve 80 drawn by the user as a selection area, grouping of content can be easily achieved.

The content image identifying unit 166 may change the display mode of the content images included in the selection area 82 from the original display mode. For example, the color of the content images may be changed. or a certain mark may be assigned to the content images. This provides the user with information indicating whether the content image is included in the selection area 82.

Described above is an explanation based on an exemplary embodiment. The embodiment is intended to be illustrative only and it will be obvious to those skilled in the art that various modifications to constituting elements and processes could be developed and that such modifications are also within the scope of the present invention.

What is claimed is:

1. An electronic device provided with a display, comprising:
a first displaying unit configured to display a content image on the display;
a first acknowledging unit configured to acknowledge an instruction for selection of a displayed content image;
a second displaying unit configured to display a plurality of menu items defined for the selected content image so as to surround the content image;
a second acknowledgment unit configured to acknowledge an instruction for selection of a displayed menu item; and
an execution unit configured to execute a function of the selected menu item.

2. The electronic device according to claim 1,
wherein the display is implemented by a touch panel.

3. The electronic device according to claim 1,
wherein the second displaying unit situates the plurality of menu items along a single circle.

4. The electronic device according to claim 1,
wherein the second displaying unit rotates the plurality of menu items around the content image.

5. The electronic device according to claim 1,
wherein the second displaying unit defines a size of a display area of menu items in accordance with the number of menu items defined for the selected content image.

6. A method of displaying a menu comprising:
displaying a content image on a display;
acknowledging an instruction for selection of a displayed content image; and
displaying a plurality of menu items defined for the selected content image, rotating the menu items around the content image.

7. A program embedded in a non-transitory computer readable recording medium, comprising:
a first display module configured to display a content image on a display;
an acknowledgment module configured to acknowledge an instruction for selection of a displayed content image; and
a second display module configured to display a plurality of menu items defined for the selected content image, rotating the menu items around the content image.

8. An electronic device provided with a display, comprising:
a sensor configured to detect a movement of the electronic device;
a storage configured to store a plurality of content images;
a determination unit configured to determine whether the electronic device makes a predetermined movement by referring to a value detected by the sensor;
an extraction unit configured to extract a plurality of content images from the storage when the electronic device makes the predetermined movement; and
a display unit configured to display the plurality of extracted content images on the display.

9. The electronic device according to claim 8, further comprising:
an action determining unit configured to determine an action of the content images displayed on the display in accordance with a value detected by the sensor,
wherein the displaying unit displays the content images such that the content images make the determined action.

10. The electronic device according to claim 8,
wherein the extraction unit extracts a predetermined number of content images from the storage.

11. The electronic device according to claim 8,
wherein, when the plurality of content images are displayed by the display unit, the extraction unit extracts, by a number of the content images currently displayed, a plurality of replacement content images from the storage, and
wherein the display unit displays a plurality of replacement content images extracted by the extraction unit to replace all of the currently-displayed content images.

12. The electronic device according to claim 8,
wherein, when the plurality of content images are displayed by the display unit, the extraction unit extracts, by a number fewer than the content images currently displayed, a plurality of replacement content images from the storage, and
wherein the display unit displays a plurality of replacement content images extracted by the extraction unit to replace some of the currently-displayed content images.

13. A content image displaying method comprising:
determining whether an electronic device makes a predetermined movement by referring to a value detected by a sensor for detecting a movement of the electronic device;
extracting a plurality of content images from a storage when the electronic device makes the predetermined movement;
displaying the plurality of extracted content images on a display;
determining an action of each of the plurality of content images displayed on the display in accordance with the value detected by the sensor; and
moving and displaying the plurality of content images such that the content images make the determined action.

14. A program embedded in a non-transitory computer readable program and adapted for a computer installed on an electronic device, the program comprising:
a determination module configured to determine whether the electronic device makes a predetermined movement by referring to a value detected by a sensor for detecting a movement of the electronic device;
an extraction module configured to extract a plurality of content images from a storage when the electronic device makes the predetermined movement;
a first display module configured to display the plurality of extracted content images on a display;
a determination module configure to determine an action of each of the plurality of content images displayed on the display in accordance with the value detected by the sensor; and
a second display module configured to move and display the plurality of content images such that the content images make the determined action.

15. An electronic device comprising:
a touch panel including a display and a positional information output device configured to output positional information identifying a touched position on the display;
a first display unit configured to display one or more content images on the display;
an acknowledging unit configured to acknowledge the positional information output from the positional information output device;
a definition unit configured to define an area as a selection area when the area is deemed as a closed or substantially closed area formed by the positional information acknowledged by the acknowledging unit successively over time;
an identification unit configured to identify one or more content images included in the selection area; and
an execution unit configured to execute a function defined for the identified content image.

16. The electronic device according to claim 15,
wherein the identification unit organizes the one or more content images identified into a group, and
wherein the execution unit executes a function commonly defined for the content images forming the group.

17. The electronic device according to claim 15,
wherein, when a new content image is included in the selection area, the identification unit adds the new content image to the group, and, when a content image included in the selection area is removed from the selection area, the identification unit excludes the removed content image from the group.

18. The electronic device according to claim 15,
wherein the identification unit changes a display mode of the one or more content images included in the selection area.

19. A function execution method comprising:
displaying one or more content images on a display;
acknowledging positional information identifying a touched position on the display;
defining an area as a selection area when the area is deemed as a closed or substantially closed area formed by the positional information acknowledged successively over time;
identifying a content image included in the selection area; and
executing a function defined for the identified content image.

20. A program embedded in a non-transitory computer readable recording medium, comprising:
a display module configured to display one or more content images on a display;
an acknowledgment module configured to acknowledge positional information identifying a touched position on the display;
a definition module configured to define an area as a selection area when the area is deemed as a closed or substantially closed area formed by the positional information acknowledged successively over time;
an identification module configured to identify a content image included in the selection area; and
an execution module configured to execute a function defined for the identified content image.
